(19) United States
(12) Patent Application Publication
(10) Pub. No.: US 2026/0287442 A1
(43) Pub. Date: Sep. 24, 2026

(54) SAMPLE TEMPERATURE ESTIMATES

(71) Applicant: Dimer Instruments, Inc., Santa Barbara, CA (US)

(72) Inventors: Michael I. Larkin, Santa Barbara, CA (US); Stephen C. Minne, Santa Barbara, CA (US); Xingfu Du, Goleta, CA (US); Matthew Devlin, Santa Barbara, CA (US)

(21) Appl. No.: 19/082,968

(22) Filed: Mar. 18, 2025

(51) Int. Cl. G01K 7/42

(52) U.S. Cl. CPC G01K 7/427; G01K 2213/00

(57) ABSTRACT

A method, system, and apparatus for estimating the temperature through time of a fluid sample in a multi-sample holder is disclosed. The method includes modeling the temperature through time of one or more fluid samples in a connected region. The connected region includes a specified fluid sample. The modeling of the temperature through time is based on properties of the multi-sample holder and properties of the one or more fluid samples.

### BACKGROUND

For many applications it is important to accurately know the temperature of a fluid sample in a microwell plate (also called a “well plate,” or simply a “plate”). One example is when ramping temperature in order to measure the melting point of protein samples in a well plate, also called the unfolding or denaturation temperature. In that case, the temperature of the fluid sample in the well is the critical parameter of the measurement. Another example is when performing Dynamic Light Scattering (DLS) measurements of fluid samples as a function of temperature. The temperature of the fluid changes the viscosity of the fluid and also the diffusion coefficient of molecules in the fluid, and so is a critical input parameter for calculating the size and size distribution of the samples from DLS data.

The temperature of a fluid sample in a microwell plate is usually not directly measured. It is often inferred by measuring the environmental temperature near the well plate, e.g. by measuring the temperature of the air near the well plate or the temperature of a solid surface or fluid bath in direct contact with the well plate. The temperature of the environment is often assumed to be the same as the temperature of the fluid samples in a well plate. However, due to imperfect conduction of thermal energy between the environment and the fluid sample, and the thermal mass of the sample, when temperature changes occur in the surrounding environment the temperature of the fluid sample will always lag in time the temperature of the surrounding environment. This temperature lag may be modeled, potentially improving the estimate of the sample temperature. However, there are several complications that can result in unacceptably large inaccuracies when modeling the temperature of the fluid sample, making the method ineffective. Therefore, there is a need for an approach to improve modeling of the temperature of fluid samples in microwell plates.

### SUMMARY

Disclosed herein are methods, systems, and apparatus for estimating the temperature through time of a fluid sample in a multi-sample holder. As described above, known methods assume sample temperature to be the environmental temperature of the multi-sample holder. However, the lag between environmental temperature and fluid sample temperature renders this assumption inaccurate, particularly for applications where the environmental temperature is changed rapidly. Additionally, various environmental conditions present complications for modeling the temperature through time of fluid samples in multi-sample holders which may result in highly inaccurate temperature estimates. A method for estimating the temperature through time of one or more fluid samples in a multi-sample holder disclosed herein includes considering one or more properties of both the multi-sample holder and properties of the fluid samples in order to model the temperature through time of one or more fluid samples in a connected region.

Disclosed herein are methods to improve modeling of the temperature of fluid samples in a well plate based on temperatures measured external to the fluid samples, by taking into account factors common to all samples in a well plate, such as the thermal conductivity, heat capacity, and thickness of the material from which the well plate is constructed, and the shape of the structure holding the sample, along with factors associated with individual samples in individual wells, such as individual sample volume, heat capacity, sample location in the well plate with respect to plate edges, sample location with respect to other samples, and the presence and characteristics of evaporation barriers. By taking into account these factors, it is possible to more accurately model the temperature of fluid samples in a well plate, thereby improving the accuracy of measurements that rely on knowing the temperature of a fluid sample in microwell plates.

Microplates, often referred to as microwell plates or simply “plates,” have become a fundamental component in many laboratory and industrial processes due to their capacity for handling multiple discrete samples in parallel. The typical microplate design consists of a rectangular frame with an array of wells, each of which can contain small volumes of liquids or reagents. This arrangement facilitates high-throughput experiments, enabling researchers to test numerous conditions, doses, or samples simultaneously. Microplates are essential in various applications such as enzyme-linked immunosorbent assays (ELISAs), cell culture, biochemical screening, pharmaceutical development, and more. The uniform dimensional standards of microplates have further contributed to widespread adoption, ensuring compatibility with automated systems, plate readers, and other common laboratory instruments.

One important application area for microplates is the measurement of protein stability and protein-ligand interactions under varying temperatures. When a researcher aims to determine the melting temperature of a protein (e.g., unfolding or denaturation temperature), microplates make it possible to process many samples at once. When performing these assays, temperature control is paramount. Small deviations in temperature can significantly impact the accuracy of protein melting data. For instance, incomplete or inconsistent heating across the plate wells can lead to erroneous measurements of denaturation temperatures, reducing confidence in screening outcomes.

Another critical area that relies on precise temperature control in microplates is Dynamic Light Scattering (DLS). DLS is widely employed in chemistry, biology, and physics to determine the size and size distributions of molecules and particles in solution. The underlying principle of DLS is that particles or molecules undergoing Brownian motion in a fluid scatter light in a manner correlated to their diffusion coefficients, which in turn depend on fluid viscosity. Because viscosity is temperature-dependent, the accuracy of DLS measurements is closely tied to how well the sample temperature is known and maintained. Even slight temperature fluctuations can alter the diffusion coefficient, thus skewing size calculations.

In the context of microplate-based DLS, variations in measured DLS parameters can arise from differences in temperature across wells. There are known benefits of using microwell plates as a high-throughput characterization tool in biopharmaceutical development. However, temperature gradients within the plate can lead to inconsistencies in DLS measurements.

Additionally, microplates are subject to “edge effects” in which the temperature profile of peripheral wells (e.g., wells having one or more sides that do not border an adjacent well) do not always match the temperature profile of central wells (e.g., wells surrounded by adjacent wells on all sides). This phenomenon of “edge effects” where evaporation and differing thermal conditions at the plate edges can result in systematic measurement deviations.

These temperature-related challenges, sometimes called “plate effects,” are not limited to DLS or melting temperature assays alone. Plate effects can arise in a variety of temperature-sensitive assays. For example, when microplates are placed in an instrument or an incubator, the ambient temperature or the temperature of the supporting surface (e.g., a heating block or fluid bath) is often used as a proxy for the sample temperature. However, the actual fluid inside each well experiences a temperature profile influenced by multiple factors. These factors may include the thermal conductivity and thickness of the plate material, the sample volume, and the sample's location on the plate (e.g., near edges or corners versus centrally located wells). A high-throughput experiment may expose dozens or hundreds of wells to slightly different environmental conditions, leading to unexpected variability in assay results.

Known methods to address these issues include both hardware and procedural methods. For instance, “segmented” plate designs have been proposed to physically isolate regions of the plate in an effort to minimize thermal gradients or cross-contamination. Segmented plate designs can mitigate some temperature non-uniformity by effectively creating smaller “sub-plates” that can each be heated or cooled more uniformly.

Another known approach is to allow samples to equilibrate to a stable temperature condition before readings. By giving the fluid in each well sufficient time to reach the set temperature, discrepancies caused by transient heat flow can be reduced. This approach (i.e., waiting for equilibration) is not viable for high throughput applications where temperature may be ramping at a high rate (e.g., 1C/min).

Additional complexities arise when the experimental workflow requires rapidly cycling the temperature, such as in thermal ramping protocols for studying protein folding or unfolding, polymerase chain reaction (PCR), or other temperature-sensitive processes. In those examples, an assumption that the fluid temperature instantly matches the environment's temperature is especially problematic. Thermal mass, conduction inefficiencies, and evaporative losses from the well surface can all combine to produce a real fluid temperature that lags the nominal set temperature. Modeling this temperature lag, while possible in theory, is difficult. The difficulty increases if the necessary material and sample properties are not precisely known or if subtle variations in volume or well position cause systematic errors.

Accordingly, there remains a need for improved methods of accurately estimating or modeling the temperature within individual wells of a microplate in real time, especially in high-throughput contexts where direct measurement of each well's temperature (for example, via an embedded sensor in every well) is not always feasible. While known methods include using segmented plates and protocols recommending temperature equilibration, these method do not fully address the challenges posed by transient heating or cooling processes across many wells. In DLS applications, in particular, precise temperature control is essential to determining accurate diffusion coefficients and, consequently, particle sizes. Similar precise temperature control is required for protein melting temperature assays, where a small temperature difference (e.g., a single-degree difference) can shift the apparent inflection point of protein unfolding.

Disclosed herein is an improved modeling approach that factors in well-specific and plate-wide properties, including each well's location, sample volume, and the plate material's thermal characteristics. By correcting for both universal and well-specific variables, the methods disclosed herein offer a more robust technique to track and predict fluid temperatures in the samples in a microplate, thereby enhancing the reliability of measurements reliant on accurate temperature knowledge. This improvement is particularly relevant to dynamic applications—such as ramped-temperature protein stability assays or DLS measurements—where the fluid sample temperature lags behind the environmental temperature. Through the appropriate modeling of thermal lag and edge effects, the presently disclosed methods improve consistency and reliability of experimental results from microplates, regardless of the specific assay or analytical platform in use.

Aspects of the subject matter described herein may be useful alone or in combination with one or more other aspect described herein. Without limiting the foregoing description, in a first aspect of the present disclosure, a method for estimating the temperature through time of a specified fluid sample in a multi-sample holder includes modeling the temperature through time of one or more fluid samples in a connected region, the connected region including the specified fluid sample, wherein the modeling is based on properties of the multi-sample holder and properties of the one or more fluid samples.

In accordance with a second aspect of the present disclosure, which may be used in combination with the first aspect, the properties of the multi-sample holder include one or more of thermal conductivity of the material of the multi-sample holder, heat capacity of the material, thickness of the material, and shape of individual fluid sample holders.

In accordance with a third aspect of the present disclosure, which may be used in combination with any other aspect disclosed herein, the properties of the one or more fluid samples include one or more of fluid sample volume, heat capacity of the fluid sample, sample location in the multi-sample holder, sample location in the connected region, presence of an evaporation barrier, and characteristics of the evaporation barrier.

In accordance with a fourth aspect of the present disclosure, which may be used in combination with any other aspect disclosed herein, the modeling is performed using theoretical models with coupled integral or differential equations, wherein a number of the coupled integral or differential equations is the same as a number of the fluid samples in the connected region.

In accordance with a fifth aspect of the present disclosure, which may be used in combination with any other aspect disclosed herein, the coupled integral or differential equations are solved numerically.

In accordance with a sixth aspect of the present disclosure, which may be used in combination with any other aspect disclosed herein, the modeling is performed using theoretical models with uncoupled integral or differential equations.

In accordance with a seventh aspect of the present disclosure, which may be used in combination with any other aspect disclosed herein, the uncoupled integral or differential equations are solved numerically.

In accordance with an eighth aspect of the present disclosure, which may be used in combination with any other aspect disclosed herein, the modeling is performed using finite element analysis methods.

In accordance with a ninth aspect of the present disclosure, which may be used in combination with any other aspect disclosed herein, the modeling is performed using an empirical method.

In accordance with a tenth aspect of the present disclosure, which may be used in combination with any other aspect disclosed herein, the empirical method includes interpolating the temperature through time of the one or more fluid samples from empirical data.

In accordance with an eleventh aspect of the present disclosure, which may be used in combination with any other aspect disclosed herein, the empirical method includes extrapolating the temperature through time of the one or more fluid samples from empirical data.

In accordance with a twelfth aspect of the present disclosure, which may be used in combination with any other aspect disclosed herein, the empirical method includes fitting measured values to functional forms as a function of multi-sample holder and sample parameters; and using the functional forms to estimate the temperature through time.

In accordance with a thirteenth aspect of the present disclosure, which may be used in combination with any other aspect disclosed herein, the modeling is based on a combination of theoretical models with integral or differential equations and empirical results.

In accordance with a fourteenth aspect of the present disclosure, which may be used in combination with any other aspect disclosed herein, the modeling is based on a combination of finite element analysis models and empirical results.

In accordance with a fifteenth aspect of the present disclosure, which may be used in combination with any other aspect disclosed herein, a method of optimizing placement of fluid samples in a multi-sample holder includes modeling the temperature through time of one or more fluid samples in a connected region, wherein the modeling is based on properties of the multi-sample holder and properties of the one or more fluid sample; and optimizing the placement of samples based on the modeling to minimize temperature lag time between the fluid samples and the environment of the multi-sample holder.

In accordance with a sixteenth aspect of the present disclosure, which may be used in combination with any other aspect disclosed herein, the modeling is performed using theoretical models with coupled integral or differential equations, wherein a number of the coupled integral or differential equations is the same as a number of the fluid samples in the connected region.

In accordance with a seventeenth aspect of the present disclosure, which may be used in combination with any other aspect disclosed herein, the modeling is performed using theoretical models with uncoupled integral or differential equations.

In accordance with an eighteenth aspect of the present disclosure, which may be used in combination with any other aspect disclosed herein, the modeling is performed using finite element analysis methods.

In accordance with a nineteenth aspect of the present disclosure, which may be used in combination with any other aspect disclosed herein, the modeling is performed using an empirical method.

In accordance with a twentieth aspect of the present disclosure, which may be used in combination with any other aspect disclosed herein, the modeling is based on a combination of theoretical models with integral or differential equations and empirical results.

In accordance with a twenty-first aspect of the present disclosure, which may be used in combination with any other aspect disclosed herein, the modeling is based on a combination of finite element analysis models and empirical results.

In accordance with a twenty-second aspect of the present disclosure, which may be used in combination with any other aspect disclosed herein, the optimizing includes placement of dummy solvent samples to improve uniformity of the fluid sample temperatures.

In accordance with a twenty-third aspect of the present disclosure, which may be used in combination with any other aspect disclosed herein, method of optimizing placement of fluid samples in a multi-sample holder includes modeling the temperature through time of one or more fluid samples in a connected region, wherein the modeling is based on properties of the multi-sample holder and properties of the one or more fluid sample; and optimizing the placement of samples based on the modeling to minimize errors in the modeling of the temperature through time of the one or more fluid samples.

In accordance with a twenty-fourth aspect of the present disclosure, which may be used in combination with any other aspect disclosed herein, the modeling is performed using a combination of one or more of theoretical models, finite element analysis methods, and empirical models.

In accordance with a twenty-fifth aspect of the present disclosure, any of the structure and functionality illustrated and described in connection with FIGS. 1 to 10 may be used in combination with any of the structure and functionality illustrated and described in connection with any of the other of FIGS. 1 to 10 and with any one or more of the preceding aspects.

In light of the present disclosure and the above aspects, it is therefore an advantage of the present disclosure to track and predict fluid temperatures in samples in a multi-sample holder.

It is another advantage of the present disclosure to enhance the reliability of measurements reliant on accurate knowledge of fluid sample temperatures in multi-sample holders.

It is a further advantage of the present disclosure to ensure that experimental results from microplates are more consistent and reproducible.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 illustrates a typical 384 microwell plate, according to an example embodiment of the present disclosure.

FIG. 2A illustrates a side view of a fluid sample in a single well of a microwell plate, according to an example embodiment of the present disclosure.

FIG. 2B illustrates a top view of a 3×3 region of a well plate for the case of a sample in the middle well and with air in the surrounding wells, according to an example embodiment of the present disclosure.

FIG. 3 is a system diagram that illustrates an example well plate in use with a computer system, according to an example embodiment of the present disclosure.

FIG. 4A illustrates an example fluid sample in a single well with parameters of interest shown, according to an example embodiment of the present disclosure.

FIG. 4B illustrates the example fluid sample of FIG. 4B with the surrounding wells empty and the parameters of interest shown.

FIG. 5 illustrates an example well plate including samples in adjacent wells with arrows indicate the potential path and direction for the flow of thermal energy, according to an example embodiment of the present disclosure.

FIG. 6 illustrates an example placement of samples in a well plate with fluid samples in some wells with air in other wells, used for simulation, according to an example embodiment of the present disclosure.

FIG. 7 illustrates a simulation of step change in air temperature, and the associated temperature through time in wells S1, S2, S3 of FIG. 6, according to an example embodiment of the present disclosure.

FIG. 8A illustrates a top view of a visualization of the 3D voxels of a well plate with loaded sample for finite element analysis, according to an example embodiment of the present disclosure.

FIG. 8B illustrates the arrangement of the materials of the 3D voxels of FIG. 8A.

FIG. 8C illustrates a perspective view of the 3D voxels of FIGS. 8A-8B.

FIG. 9 illustrates voxels of the finite element analysis model assigning reference frame and indexing, according to an example embodiment of the present disclosure.

FIG. 10 illustrates an example well plate used to empirically determine thermal lab between samples and the environment, according to an example embodiment of the present disclosure.

FIG. 11 is a flow diagram illustrating an example procedure for optimizing sample placement in a multi-sample holder, according to an example embodiment of the present disclosure.

### DETAILED DESCRIPTION

The present disclosure relates in general to a method, system, and apparatus for estimating the temperature through time of a fluid sample in a multi-sample holder. As disclosed herein, the method comprises a modeling approach that considers sample-specific and/or multi-sample holder global characteristics to provide a reliable technique to track and predict fluid temperatures in the samples of a multi-sample holder, thereby enhancing the reliability of measurements reliant on accurate temperature knowledge.

The temperature of a fluid sample in a microwell plate may be a critical parameter. However, this temperature is typically not directly measured. In many examples, the temperature of a fluid sample in a microwell plate is inferred by measuring the environmental temperature near the well plate. For example, the temperature may be inferred by measuring the temperature of the air near the well plate or the temperature of a solid surface or fluid bath in direct contact with the well plate. Due to imperfect conduction of thermal energy between the environment and the fluid sample, and due to the thermal mass of the sample, when temperature changes occur in the surrounding environment the temperature of the fluid sample will typically lag in time the temperature of the surrounding environment. With mathematical modeling it is possible to use the temperature history of the surrounding environment along with assumed thermal parameters regarding fluid samples in a well plate to estimate the temperature of a fluid sample. However, improper use of such models (e.g., without proper consideration of temperature influencing factors) can result in gross inaccuracies in the estimated sample temperature potentially making the modeled temperature much less accurate than simply assuming that the fluid sample is at the current temperature of the environment.

Consideration of one or more factors which influence temperature in the modeling of fluid sample temperatures can improve temperature estimates. These same factors, if ignored, can reduce the accuracy of temperature estimates. These factors include sample volume, presence of an evaporation barrier, characteristics of an evaporation barrier, multi-sample holder material, topology of the multi-sample holder, the position of a sample relative to other samples, and the position of a sample within the multi-sample holder.

For example, with well plates it is common to use sample volumes anywhere from 1-200 μL, resulting in a factor of ~200 difference in thermal time constants and potential gross inaccuracies when calculating temperature lag times and estimating sample temperature. Regarding evaporation barriers, oil is sometimes dispensed on top of aqueous samples in a well plate to mitigate evaporation, with varying volumes of oil. Due both to the thermal mass of the oil and the change in thermal conductivity from the environment into the sample, the presence of oil as an evaporation barrier also can lead to large variations in the sample thermal time constant. Rather than using oil to mitigate evaporation, a film cover over a well plate is sometimes used, and the film cover results in a change in thermal conductivity between the environment and the sample, changing the sample thermal time constant.

Properties of the multi-sample holder are also factors that influence fluid sample temperature estimates. For example, different well plates can be made from different materials (e.g., polyurethane, polystyrene, cyclo-olefin, metal, glass, etc.) with a variety material thicknesses and associated differing thermal conductivities and thermal masses. The material properties of the multi-sample holder thus also affect the sample thermal time constant. Further, different well plates have different topologies. For example, some well plates have square wells while others may have round wells. The topological differences can change the ratio of sample surface area to sample volume, resulting in changes to the sample thermal time constant.

Additionally, the location of a sample relative to other samples and/or the location of the sample within the well plate can affect the thermal time constant of the sample. For example, if a well that contains a fluid sample is surrounded by empty wells (e.g., wells containing air), then the sample in that well will have a reduced thermal time constant with respect to changes in air temperature as compared to samples that are in wells that are surrounded by other wells containing samples. If there is a block of wells containing samples, then samples in the middle of the block will have the longest thermal time constants, the samples near the edge of the block will have reduced thermal time constants, samples at the corners of the block will have the shortest thermal time constants. Moreover, the position of a sample with respect to the center vs the edge or corner of a well plate can alter the conduction of thermal energy to/from the environment, and thus affect the sample thermal time constant.

Disclosed herein are methods to use thermal modeling to improve the estimate of the temperature of a fluid sample in a well plate, taking into account any of: volume of the sample, thermal mass of the sample, thermal mass of the various elements of the well plate, thermal conductivity of the various elements of the well plate, any evaporation mitigation strategies, including oil or film covers, specific construction of the well plate, including materials, material thicknesses, well topology, and position of the sample in the well plate with respect to other samples and with respect to the center vs the edges of a well plate. With these inputs it is possible to improve temperature modeling and estimates of the temperature of a fluid sample in a well plate, given the temperature history of the environment of the well plate.

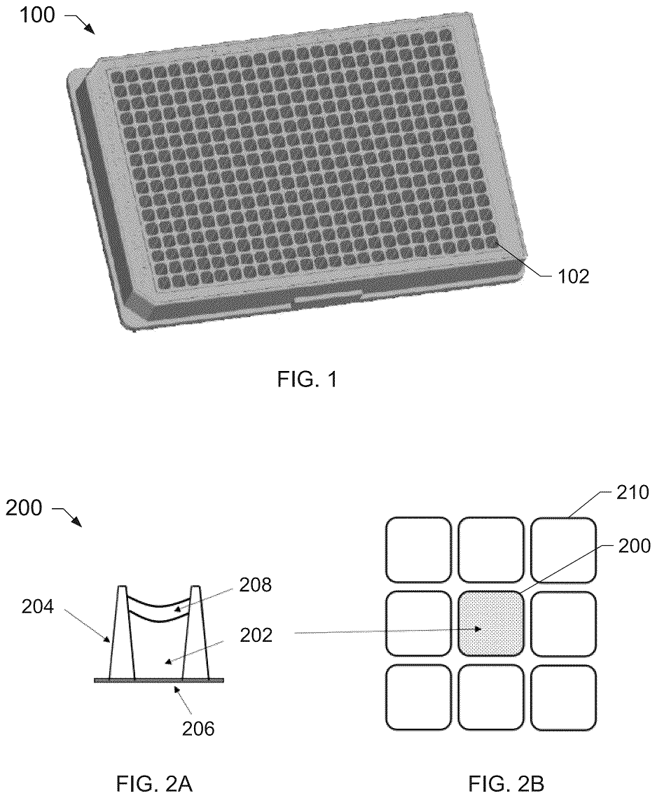

FIG. 1 shows an image of an example well plate 100. The example well plate 100 includes 384 individuals wells 102 arranged in a grid of 16 wells by 24 wells. In some examples, each axis of the grid of wells may be labeled so as to easily identify the location of a particular well. For example, the horizontal axis of wells may be labeled with numbers while the vertical axis of wells may be labeled with letters. Accordingly, the individual well 102 may have a label of P24. The example well plate 100 is constructed of a material (e.g., polyurethane, polystyrene, cyclo-olefin, metal, glass, etc.) having an associated thermal conductivity. The material thickness of the well plate 100 along with its material and thermal conductivity all contribute to the thermal mass of the well plate 100.

The individual wells 102 of the well plate 100 are roughly square shaped and can hold approximately 30-100 μL of a fluid sample. During use of the well plate 100, one or more of the individual wells 102 may be filled with a fluid sample. In some examples, the filled wells may be filled with the same fluid sample content while in other examples, different fluid samples may be filled into different wells. Individual wells 102 which are not filled with a fluid sample may contain only air. In other examples, individual wells 102 which are not filled with a fluid sample may be filled with a “dummy” solvent sample (e.g., a sample containing a suitable solvent but not including any material for which a measurement is sought). In some cases, the filled wells may be filled with the same volume in each filled well, while in other cases, each filled well may have a different fill volume.

While examples disclosed herein are discussed using the example of a well plate such as the 384 microwell plate 100 of FIG. 1, it should be understood that the methods disclosed herein are applicable to estimation of sample temperatures for samples in other types multi-sample holders. For example, an applicable multi-sample holder may be a well plate having different quantity or size of wells than the well plate 102 of FIG. 1. Additionally, there are other matrixed element, or tessellated, multi-sample holders that are used in thermal applications. For example, other example multi-sample holders include custom quartz glass sample holders and/or capillary arrays for high throughput thermal analysis. These types of multi-sample holders also present the same issues as standard well plates in estimating fluid sample temperature over time. It should be understood that exampled disclosed herein with respect to well plates are also applicable to these other types of multi-sample holders as well. In particular, the sample temperature lags the setpoint temperature where the amount of lag depends on the details of the thermal ramp, sample, sample holder, fill factor, sealing, etc. Thus, the same approaches described herein could be applied to these sample holders.

FIGS. 2A-2B show schematically an example well 200 having a fluid sample 202. FIG. 2A shows a side view of the example well 200. The example well 200 is constructed of well side walls 204 and a well bottom 206. A layer of oil 208 is situation atop the fluid sample 202 within the example well 200. The layer of oil 208 is used to mitigate evaporation of the fluid sample 202. FIG. 2B shows a top view of a 3 by 3 region of a well plate having the middle well 200 filled with a sample and the surrounding wells 210 filled with air. The wells shown in FIG. 2B including the example filled well 200 and the surrounding air filled wells 210 are square shaped.

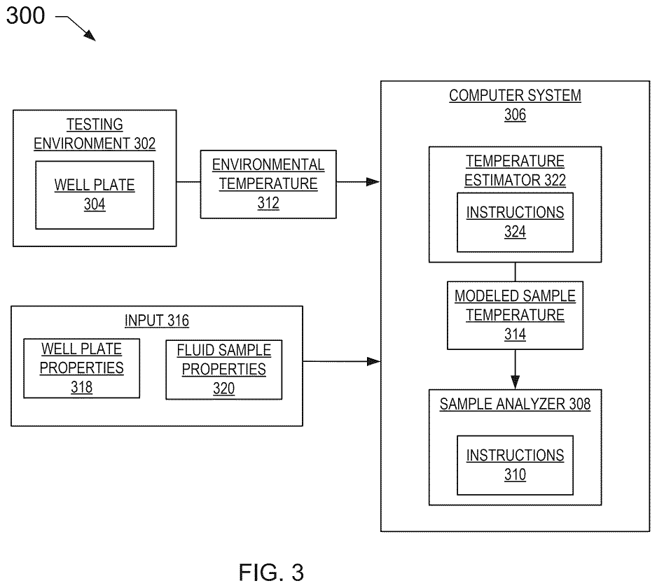

FIG. 3 shows a schematic of a testing system 300, according to an example embodiment of the present disclosure. The testing system 300 is improved compared to known testing systems by implementing accurate modeling of sample temperatures over time and using the modeled sample temperatures to inform and improve sample analysis. The example testing system 300 includes a testing environment 302 having a well plate 304. In some examples, the well plate corresponds to a 384 microwell plate such as the well plate 102 of FIG. 1. In other examples, the well plate 304 may be any other suitable multi-sample holder.

The example testing system 300 includes a computer system 306 including a sample analyzer 308. The sample analyzer 308 uses the instructions 310 to perform analysis of samples loaded in the well plate 304 based on one or more measurements of the samples taken in the testing environment 302. As described above, one of the measurements used to analyze the samples may be a temperature of the samples over time. An environmental temperature 312 (e.g., air temperature over time) is measured during testing and provided to the computer system 306. In known testing systems, sample temperature over time is assumed to correspond to the environmental temperature 312. In contrast, in the example testing system 300, the example environmental temperature 312 is used by the computer system 306 to determine modeled sample temperature 314 (e.g., temperature over time modeled for each sample in the well plate 304) which is used to inform and improve sample analysis by the sample analyzer 308.

In addition to the environmental temperature 312, the computer system 306 receives additional input 316. The example input 316 includes well plate properties 318 and fluid sample properties 320. The example well plate properties 318 may include a well plate type, which corresponds to a table that specifies the number of rows, the number of columns, individual well shape, individual well dimensions, wall thickness and plate material. The example fluid sample properties 320 may include the sample type or contents of each well, the volume of the sample or contents and the presence and characteristics of an evaporation barrier for each well.

The example computer system 306 further includes a temperature estimator 322. The example temperature estimator 322 uses instructions 324 to determine the modeled sample temperature 314 based on the environmental temperature 312 and the input 316 including the well plate properties 318 and the fluid sample properties 320. The instructions 324 may also include instructions for determining optimal placement of fluid samples in the well plate 304.

The sample temperature of a fluid sample such as fluid sample 202 of FIG. 2 through time is given by Equation 1. In Equation 1, T₀ represents the starting temperature (units of C), Pₜₒₜ(t) represents the total thermal power entering or leaving the sample as a function of time (units of W), and κₛₐₘₚ represents the heat capacity or “thermal mass” of the sample (units of J/C).

$${T}_{samp} ( t ) = {T}_{0} + {\int }_{0}^{t} \frac{{P}_{tot} ( τ )}{{κ}_{samp}} d τ \qquad ( Equation 1 )$$

The heat capacity of the fluid sample (κₛₐₘₚ) is given by the quantity of fluid sample in the well and the specific heat capacity of the fluid. The total thermal power entering or leaving the sample through time (Pₜₒₜ(t)) is given by the temperature difference between the sample and surrounding elements (e.g. the air or nearby wells) and the thermal conductivity between each of those elements and the sample. Calculation and estimation of Pₜₒₜ(t) through time may be achieved using one or more of the methods disclosed herein. These methods include calculation based upon a theoretical model, calculation based on a finite element analysis model of the system, estimated from empirical measurements along with interpolation or extrapolation to specific conditions, or estimated based on a combination of any or all of these methods. Examples of each method are disclosed below.

### Calculations Based on a Theoretical Model

### Simple Case for a Theoretical Model

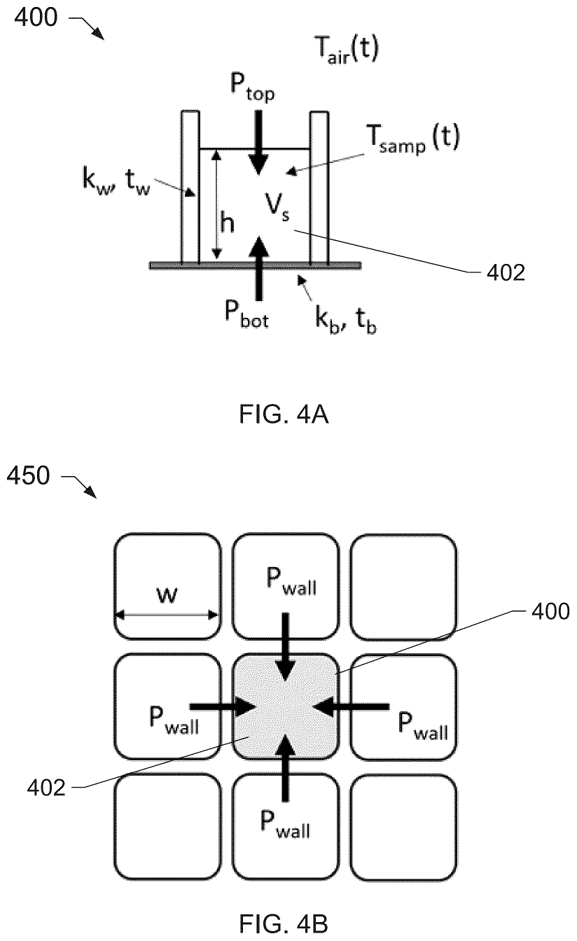

Error! Reference source not found.A-4B show an example fluid sample 402 in a single well 400 with empty surrounding wells 419. In FIGS. 4A-4B, parameters of interest for the fluid sample 402 are shown. Parameters of interest shown in FIG. 4A which contribute to Pₜₒₜ are power conduction from the top and bottom (Pₜₒₚ and P_{bot}) and power conduction through each of the four nearest neighbor wells (P_{wall}). The volume of the fluid sample 402 is Vₛ. The thermal mass of the sample (κₛₐₘₚ) is calculated by multiplying the volume (Vₛ) by the heat capacity of the sample (cₛₐₘₚ). The thermal conductivity and thickness of the wall and of the bottom, are respectively k_{w}, t_{w} and k_{b}, t_{b}. The width of a well is w and h is the height of the fluid in the well, which is known from the sample volume and the well dimensions.

Conducted thermal power may be calculated as

$${P}_{therm} = k \frac{A \cdot Δ T}{t}$$

where k is the thermal conductivity of element through which heat is being conducted, A is the area of the interface through which heat is being conducted, ΔT is the temperature difference across the element that is conducting the heat, and t is the thickness of the element conducting heat. For the example of FIG. 4, heat is transferred from the air to the surface across which heat is being conducted. Accordingly, there is an additional factor associated with the efficiency with which heat can be transferred from the air to the surface. Several methods may be used to model this additional factor. In examples disclosed herein, a dimensionless factor f is used to indicate the efficiency with which heat is transferred from the air to the surface, giving

$${P}_{therm} = fk \frac{A \cdot Δ T}{t} .$$

For the case where air is in direct contact with the sample, as for Pₜₒₚ in Error! Reference source not found., the efficiency with which heat is transferred from air to sample is modeled as an effective thermal impedance I with units equivalent to Watts/(c*cm²), giving P_{air-fluid}=IAΔT.

For the example in Error! Reference source not found. we see that Pₜₒₜ is given as Equation 2 below. Substituting in the respective thermal powers in Equation 2 results in Equation 2b which may be simplified to Equation 3. In Equations 2b and 3, f_{b} and f_{w} represent the efficiency factors for heat transfer from air to the bottom surface and wall surfaces, respectively.

$${P}_{tot} ( t ) = {P}_{top} ( t ) + {P}_{bot} ( t ) + 4 {P}_{w} ( t ) \qquad ( Equation 2 )$$

$${P}_{tot} ( t ) = {Iw}^{2} ( {T}_{air} ( t ) - {T}_{samp} ( t ) ) + {f}_{b} {k}_{b} \frac{{w}^{2}}{{t}_{b}} ( {T}_{air} ( t ) - {T}_{samp} ( t ) ) + 4 {f}_{w} {k}_{w} \frac{hw}{{t}_{w}} ( {T}_{air} ( t ) - {T}_{samp} ( t ) ) \qquad ( Equation 2 b )$$

$${P}_{tot} ( t ) = ( {Iw}^{2} + {f}_{b} {k}_{b} \frac{{w}^{2}}{{t}_{b}} + 4 {f}_{w} {k}_{w} \frac{hw}{{t}_{w}} ) ( {T}_{air} ( t ) - {T}_{samp} ( t ) ) \qquad ( Equation 3 )$$

By substituting Error! Reference source not found. into Error! Reference source not found., Tₛₐₘₚ(t) can be solved for and calculated. Consolidating the parameters in Pₜₒₜ(t) results in Equation 4 below where

$$c = ( {Iw}^{2} + {f}_{b} {k}_{b} \frac{{w}^{2}}{{t}_{b}} + 4 {f}_{w} {k}_{w} \frac{hw}{{t}_{w}} )$$

as the combined thermal conductivity between the sample and the environment. Combining Equation 4 with Equation 1 results in Equation 5 below. With Tₐᵢᵣ(τ) known this may be calculated numerically in a straightforward way. Alternatively, taking the derivative of both sides, Equation 6 can be solved for. Equation 6 is also straightforward to solve numerically, given the initial condition of Tₛₐₘₚ(t=0)=T₀.

$${P}_{tot} ( t ) = c ( {T}_{air} ( t ) - {T}_{samp} ( t ) ) \qquad ( Equation 4 )$$

$${T}_{samp} ( t ) = {T}_{0} + \frac{c}{{κ}_{samp}} {\int }_{0}^{t} ( {T}_{air} ( τ ) - {T}_{samp} ( τ ) ) d τ \qquad ( Equation 5 )$$

$$\frac{d}{dt} {T}_{samp} ( t ) = \frac{c}{{κ}_{samp}} ( {T}_{air} ( t ) - {T}_{samp} ( t ) ) \qquad ( Equation 6 )$$

### General Case for a Theoretical Model, Coupled Equations

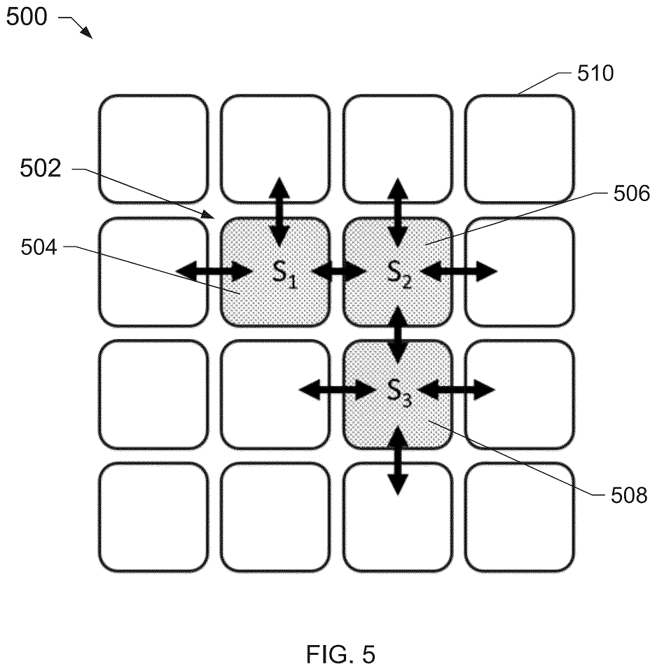

FIG. 5 shows an example grid of wells 500 with a connected region 502 of samples. As used herein, a connected region of samples refers to a group of one or more samples in a multi-sample holder where each of the samples in the connected region is adjacent to (e.g., shares a wall with) another one of the samples in the connected region. The example connected region 502 includes a first sample 504, a second sample 506, and a third sample 508. Each of the other wells 510 in the example grid of wells 500 outside of the connected region 502 represent empty wells (e.g., wells containing air).

The arrows shown in FIG. 5 represent potential paths and direction for the flow of thermal energy. FIG. 5 shows that the temperature of a sample in a well adjacent to the sample can impact the thermal power transmitted between wells. Therefore, the presence of samples in adjacent wells affects Tₛₐₘₚ(t). Accordingly, to accurately calculate an improved estimation of T_{S1}(t), T_{S2}(t) must be known. Further, to calculate an improved estimation T_{S2}(t), T_{S1}(t) and T_{S3}(t) must be known. Additionally, to calculate an improved estimation of T_{S3} (t), T_{S2}(t) must be known. Thus, the sample temperatures for wells within a connected region are seen to be coupled. As a result, accurate estimation of temperatures through time for any sample in a connected region requires self-consistently calculating the temperatures through time of all samples within the connected region.

In general, the thermal power entering or leaving a sample through time will be given by the thermal powers through each of the 6 principal faces, as shown in Equation 7 below. In Equation 7, P_{w1}-P_{w4} represent the thermal powers through each of the 4 sidewalls of a square well.

$${P}_{tot} ( t ) = {P}_{top} ( t ) + {P}_{bot} ( t ) + {P}_{w 1} ( t ) + {P}_{w 2} ( t ) + {P}_{w 3} ( t ) + {P}_{w 4} ( t ) \qquad ( Equation 7 )$$

In the example with air as the environmental temperature used to control the sample temperature, the thermal powers Pₜₒₚ(t) and P_{bot}(t) are proportional to Tₐᵢᵣ(t)−Tₛₐₘₚ(t), with the proportionality constant given by the combined thermal conductivity between the sample and the environment cₑₙᵥ given by the various surface areas, material thicknesses, and thermal conductivities of the material above and below the sample, an example of which is given in Error! Reference source not found. The specific cₑₙᵥ for a sample depends on how many neighbor wells contain sample vs contain air, and so cₑₙᵥ is different for different sample locations, but has only 5 possible values (with 0 to 4 nearest neighbor wells containing sample). The thermal powers P_{w1}-P_{w4} are proportional to the temperature difference between the sample and the temperature of the sample in the adjoining wells, with the proportionality constant again being given by the various surface areas, material thicknesses, and thermal conductivities of the material between the wells.

For the example shown in Error! Reference source not found., Pₜₒₜ(t) for each of the samples may be seen to be given by Equations 8-10 below. In Equations 8-10, c_{n,m} are the proportionality constants for thermal power flowing between wells.

$${P}_{S 1} ( t ) = {c}_{env 1} ( {T}_{air} ( t ) - {T}_{S 1} ( t ) ) + {c}_{1 , 2} ( {T}_{S 2} ( t ) - {T}_{S 1} ( t ) ) \qquad ( Equation 8 )$$

$${P}_{S 2} ( t ) = {c}_{env 2} ( {T}_{air} ( t ) - {T}_{S 2} ( t ) ) + {c}_{1 , 2} ( {T}_{S 1} ( t ) - {T}_{S 2} ( t ) ) + {c}_{2 , 3} ( {T}_{S 3} ( t ) - {T}_{S 2} ( t ) ) \qquad ( Equation 9 )$$

$${P}_{S 3} ( t ) = {c}_{env 3} ( {T}_{air} ( t ) - {T}_{S 3} ( t ) ) + {c}_{2 , 3} ( {T}_{S 2} ( t ) - {T}_{S 3} ( t ) ) \qquad ( Equation 10 )$$

Combining each of Equations 8-10 with Error! Reference source not found. results in the coupled integral equations of Equations 11-13. If Tₐᵢᵣ(τ) is known, the coupled integral equations of Equations 11-13 may be calculated numerically in a straightforward way.

$${T}_{S 1} ( t ) = {T}_{0} + \frac{{c}_{env 1}}{{κ}_{S 1}} {\int }_{0}^{t} ( {T}_{air} ( τ ) - {T}_{S 1} ( τ ) ) d τ + \frac{{c}_{1 , 2}}{{κ}_{S 1}} {\int }_{0}^{t} ( {T}_{S 2} ( τ ) - {T}_{S 1} ( τ ) ) d τ \qquad ( Equation 11 )$$

$${T}_{S 2} ( t ) = {T}_{0} + \frac{{c}_{env 2}}{{κ}_{S 2}} {\int }_{0}^{t} ( {T}_{air} ( τ ) - {T}_{S 2} ( τ ) ) d τ + \frac{{c}_{1 , 2}}{{κ}_{S 2}} {\int }_{0}^{t} ( {T}_{S 1} ( τ ) - {T}_{S 2} ( τ ) ) d τ + \frac{{c}_{2 , 3}}{{κ}_{S 2}} {\int }_{0}^{t} ( {T}_{S 3} ( τ ) - {T}_{S 2} ( τ ) ) d τ \qquad ( Equation 12 )$$

$${T}_{S 3} ( t ) = {T}_{0} + \frac{{c}_{env 3}}{{κ}_{S 3}} {\int }_{0}^{t} ( {T}_{air} ( τ ) - {T}_{S 3} ( τ ) ) d τ + \frac{{c}_{2 , 3}}{{κ}_{S 3}} {\int }_{0}^{t} ( {T}_{S 2} ( τ ) - {T}_{S 3} ( τ ) ) d τ \qquad ( Equation 13 )$$

Alternatively, taking the derivative of both sides of each of Equations 11-13 results in Equations 14-16 written as coupled first order linear differential equations. If Tₐᵢᵣ(τ) is known, these coupled differential equations may also be calculated numerically in a straightforward way.

$$\frac{d}{dt} {T}_{S 1} ( t ) = \frac{{c}_{env 1}}{{κ}_{S 1}} ( {T}_{air} ( t ) - {T}_{S 1} ( t ) ) + \frac{{c}_{1 , 2}}{{κ}_{S 1}} ( {T}_{S 2} ( t ) - {T}_{S 1} ( t ) ) \qquad ( Equation 14 )$$

$$\frac{d}{dt} {T}_{S 2} ( t ) = \frac{{c}_{env 2}}{{κ}_{S 2}} ( {T}_{air} ( t ) - {T}_{S 2} ( t ) ) + \frac{{c}_{1 , 2}}{{κ}_{S 2}} ( {T}_{S 1} ( t ) - {T}_{S 2} ( t ) ) + \frac{{c}_{2 , 3}}{{κ}_{S 2}} ( {T}_{S 3} ( t ) - {T}_{S 2} ( t ) ) \qquad ( Equation 15 )$$

$$\frac{d}{dt} {T}_{S 3} ( t ) = \frac{{c}_{env 3}}{{κ}_{S 3}} ( {T}_{air} ( t ) - {T}_{S 3} ( t ) ) + \frac{{c}_{2 , 3}}{{κ}_{S 3}} ( {T}_{S 2} ( t ) - {T}_{S 3} ( t ) ) \qquad ( Equation 16 )$$

More generally, with N wells within a connected region there will be N coupled integral equations or N coupled first order linear differential equations. These coupled equations may be solved, for example, numerically.

Error! Reference source not found. shows we give an example grid of wells 600 with sample placement that demonstrates the effect of sample location on temperature changes through time. A first sample S₁ 602 is in a well which has no samples in the nearest neighbor (e.g., adjacent) wells, and is diagonal to (but unconnected with) a connected region 604. The connected region 604 includes a 5×5 block of wells filled with samples, with the surrounding wells empty (filled with air). A second sample S₂ 606 is on a corner of the 5×5 block, and a third sample S₃ 608 is in a well in the middle of the 5×5 block.

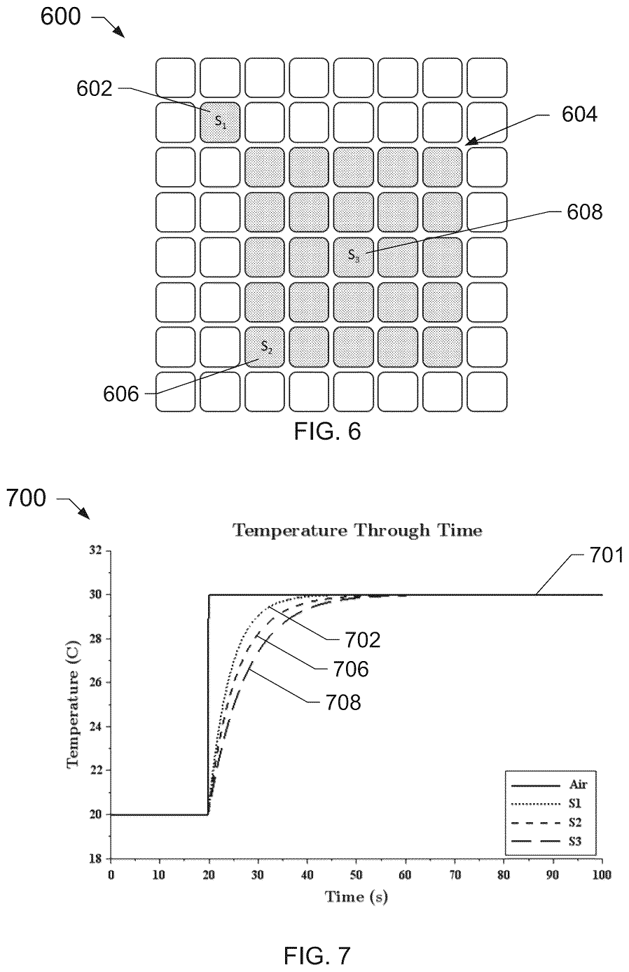

FIG. 7 shows the results of a simulation of step change in air temperature. An example scenario where the well plate was held at 20C in air for a long period of time was simulated, followed by a step change of the air temperature to 30C. The air temperature for the simulation is shown as curve 701 in the graph 700 of FIG. 7. Generally realistic values were used for sample volume, well dimension, and all thermal parameters. The coupled first order linear differential equations were then numerically solved. The results for the temperature of the first sample S₁ 602, the second sample S₂ 606 and the third sample S₃ 608 are shown in Error! Reference source not found. as the first curve 702, the second curve 706, and the third curve 708 respectively. The first sample S₁ 602 in a well with no sample in all four nearest neighbor wells changes temperature more quickly than the second sample S₂ 606, which is at the corner of the 5×5 block of filled wells. Additionally, the second sample S₂ 606 changes temperature more quickly than the third sample S₃ 608, which is in the middle of the block of filled wells.

### General Case for a Theoretical Model, Uncoupled Equations

The previous section disclosed how using the general form of Error! Reference source not found. for the thermal power entering or leaving a sample through time combined with Error! Reference source not found. can result in coupled integral or differential equations, with N connected wells resulting in N coupled equations. In this section, methods are disclosed for uncoupling the equations to have N uncoupled integral or differential equations, significantly reducing numerical complexity. Beginning with Error! Reference source not found. and taking the derivative of both sides results in Equation 17 below. Substituting in Pₜₒₜ(t) from Error! Reference source not found. into Equation 17 results in Equation 18 below. In Equation 18, P_{i,l}(t), P_{i,r}(t), P_{i,a}(t), P_{i,b}(t) represent the power through time transmitting into sample in position i from the nearest neighbor wells to the left, right, above, and below the well of interest. Using the Equations for P_{i,l}(t), P_{i,r}(t), P_{i,a}(t), P_{i,b}(t) in Equation 18 results in Equation 19 below which may be rewritten as Equation 20.

$$\frac{d}{dt} {T}_{samp} ( t ) = \frac{1}{{κ}_{samp}} {P}_{tot} ( t ) \qquad ( Equation 17 )$$

$$\frac{d}{dt} {T}_{i} ( t ) = \frac{1}{{κ}_{i}} \{ {P}_{top} ( t ) + {P}_{bot} ( t ) + {P}_{i , l} ( t ) + {P}_{i , r} ( t ) + {P}_{i , a} ( t ) + {P}_{i , b} ( t ) \} \qquad ( Equation 18 )$$

$$\frac{d}{dt} {T}_{i} ( t ) = \frac{{c}_{i , air}}{{κ}_{i}} ( {T}_{air} ( t ) - {T}_{i} ( t ) ) + \frac{{c}_{i , l}}{{κ}_{i}} ( {T}_{air} ( t ) - {T}_{i , l} ( t ) ) + \frac{{c}_{i , r}}{{κ}_{i}} ( {T}_{air} ( t ) - {T}_{i , r} ( t ) ) + \frac{{c}_{i , a}}{{κ}_{i}} ( {T}_{air} ( t ) - {T}_{i , a} ( t ) ) + \frac{{c}_{i , b}}{{κ}_{i}} ( {T}_{air} ( t ) - {T}_{i , b} ( t ) ) \qquad ( Equation 19 )$$

$$\frac{d}{dt} {T}_{i} ( t ) = {a}_{i} {T}_{air} ( t ) + {b}_{i , l} {T}_{i , l} ( t ) + {b}_{i , r} {T}_{i , r} ( t ) + {b}_{i ,} {T}_{i , a} ( t ) + {b}_{i , b} {T}_{i , b} ( t ) \qquad ( Equation 20 )$$

In Equation 20, various terms have been combined together into the a and b terms. A region of N connected wells can be expressed as Equation 21 below. In Equation 21, i goes from 1 to N and bᵢⱼ is an N×N matrix that is largely filled with zeros, since only nearest neighbor wells have thermal power flowing between them.

$$\frac{d}{dt} {T}_{i} ( t ) = {a}_{i} \cdot {T}_{air} ( t ) + {\sum }_{j = 1}^{N} {b}_{ij} {T}_{j} ( t ) \qquad ( Equation 21 )$$

The general solution to this set of coupled ordinary differential equations of Equation 21 is given by finding the homogeneous solution for the case of Tₐᵢᵣ(t)=0 and adding that to the particular solution solving with Tₐᵢᵣ(t) as nonzero. This solution is shown in Equation 22 below.

$${T}_{i} ( t ) = {T}_{i , h} ( t ) + {T}_{i , p} ( t ) \qquad ( Equation 22 )$$

For the homogeneous case, Equation 23 applies.

$$\frac{d}{dt} {T}_{i , h} ( t ) = {\sum }_{j = 1}^{N} {b}_{ij} {T}_{j , h} ( t ) \qquad ( Equation 23 )$$

Using matrix notation, expressing all of the T_{i,h}(t) as a vector of temperatures Tₕ(t), and using B=[b_{i,j}] Equation 23 becomes Equation 24 below.

$$\frac{d}{dt} {T}_{h} = B \cdot {T}_{h} \qquad ( Equation 24 )$$

B is symmetrical because well i and well j are connected and share the same thermal conduction term, e.i. b_{i,j}=b_{j,i}. Since B is symmetrical it can always be diagonalized. Assuming B is diagonalized using a similarity transformation B=S⁻¹AS and substituting it to the above equation results in Equation 25 below.

$$\frac{d}{dt} {T}_{h} = {S}^{- 1} AS \cdot {T}_{h} \qquad ( Equation 25 )$$

Multiplying both sides by S and redefine

$${T}_{h}^{′} = {ST}_{h}$$

results in Equation 26 below.

$$\frac{d}{dt} {T}_{h}^{′} = A \cdot {T}_{h}^{′} \qquad ( Equation 26 )$$

Because A is diagonal, Error! Reference source not found. represents N independent (e.g., no longer coupled) differential equations, the solution to each of which is an exponential as shown in Equation 27 below.

$${T}_{h}^{′} ( t ) = {e}^{At} {T}_{h}^{′} ( t = 0 ) \qquad ( Equation 27 )$$

The solution to the homogeneous equation may be seen to be:

$${T}_{h} ( t ) = {S}^{- 1} {T}_{h}^{′} ( t ) = {S}^{- 1} {e}^{At} {S}^{- 1} {T}_{h} ( t = 0 ) \qquad ( Equation 28 )$$

For the particular solution with Tₐᵢᵣ(t) not equal to zero, Equation 29 applies.

$$\frac{d}{dt} {T}_{p} = B \cdot {T}_{p} + {aT}_{air} ( t ) \qquad ( Equation 29 )$$

Where a is the vector of aᵢ from Equation 21. Proceeding as above, using B=S⁻¹AS results in Equation 30 below.

$$\frac{d}{dt} {T}_{p} = {S}^{- 1} {AST}_{p} + {aT}_{air} ( t ) \qquad ( Equation 30 )$$

Multiply both sides of Equation 30 by S, and substitute

$${T}_{p}^{′} = {ST}_{p}$$

results in Equation 31 below.

$$\frac{d}{dt} {T}_{p}^{′} = {AT}_{p}^{′} + {SaT}_{air} ( t ) \qquad ( Equation 31 )$$

Equation 31 may be solved by assuming that the solution has the form of Equation 32, substituting that back into Equation 31, and finding both sides to be equal.

$${T}_{p}^{′} = {\int }_{0}^{t} {Sae}^{A ( t - s )} {T}_{air} ( s ) ds \qquad ( Equation 32 )$$

Given that Equation 32 is the solution to Equation 31, Equation 33 results.

$${T}_{p} = {S}^{- 1} {T}_{p}^{′} = {\int }_{0}^{t} {ae}^{A ( t - s )} {T}_{air} ( s ) ds \qquad ( Equation 33 )$$

The complete solution may therefore be seen to be as Equation 34 below.

$$T ( t ) = {T}_{h} ( t ) + {T}_{p} ( t ) = {S}^{- 1} {e}^{At} {S}^{- 1} {T}_{h} ( t = 0 ) + {\int }_{0}^{c} {ae}^{A ( t - s )} {T}_{air} ( s ) ds \qquad ( Equation 34 )$$

With this reformulation it may be seen that each of the Tᵢ(t) within vector T(t) is no longer coupled to the solution to the temperature of the sample in any other well. For a region of N connected wells we now have N uncoupled equations, rather than N coupled equations. Reformulating in this way and computing Tᵢ(t) using Equation 34 therefore can result in a significant reduction in computation required to calculate all of the connected Tᵢ(t).

### Calculations Based on Finite Element Analysis

To perform FEA on the thermal evolution of a well plate, the well plate can be represented as a 3D grid of voxels with temperatures that evolve in time. Each voxel has a height, length, depth, thermal mass, thermal conductivity, and a convective heat transfer coefficient. Length and width of the well plate can be defined to represent the X and Y axes respectively, with the height of the well plate defining the Z axis.

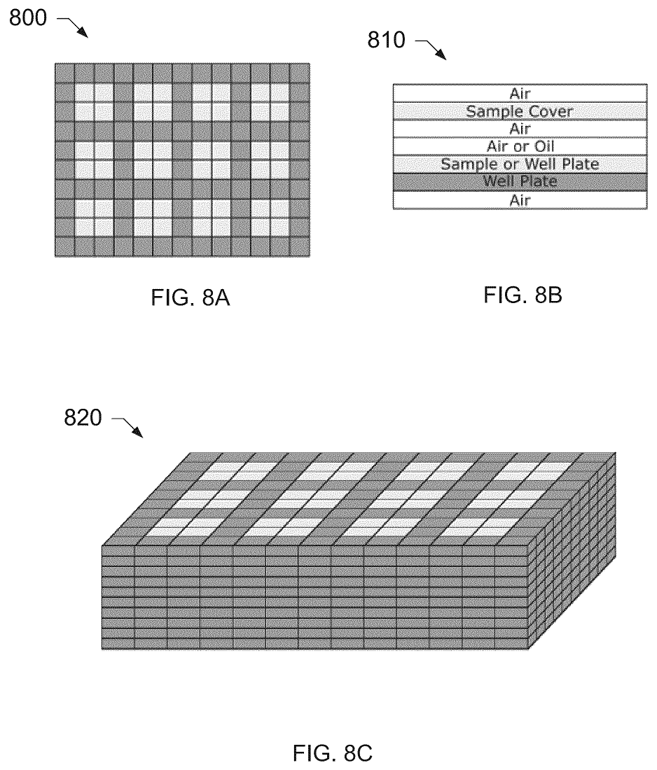

FIG. 8A shows a top view of a visualization of the 3D voxels of a well plate with loaded sample for finite element analysis. FIG. 8A demonstrates that, when looked from above in the XY plane, the 3D voxel mesh is arranged in a 2D grid consisting of blocks of well plate material and sample material. FIG. 8B shows a side view of the 3D voxels. FIG. 8B demonstrates that, when looked at from the side in the XZ or YZ planes, the 3D voxels have properties defined by the layers of the well plate, from top to bottom: Air, Sample Cover, Air, Air or Oil, Sample or Well Plate, Well Plate, and Air. The “Sample or Well Plate” layers will be sufficiently numerous to capture the dimensions of the well plate, the volume of the sample to be measured, and oil and/or air between the sample and the sample cover. Temperature will evolve throughout the system as conductive heat transfer between voxel, except for voxels adjacent to “Air” voxels, which will interact with those “Air” voxels as convective heat transfer. FIG. 8C illustrates an isometric view of the 3D voxels.

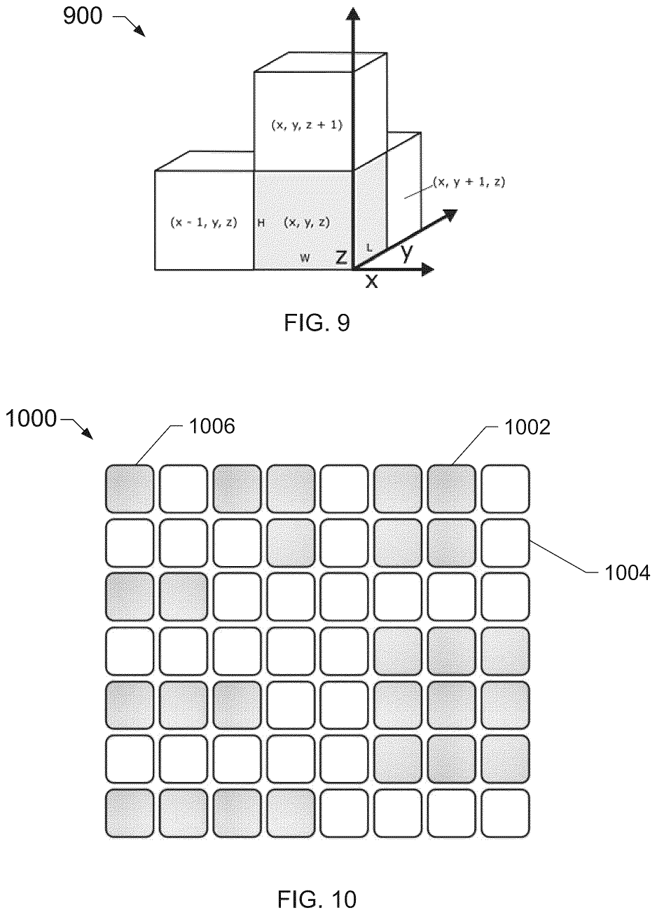

To use the FEA model sample temperatures through time, a mesh of rectangular voxel is constructed with geometric properties of length (L), width (W), and height (H). The voxel is also assigned material properties of density (ρ), specific heat (cₚ), thermal conductivity (k), convection coefficient (k_{c}), and an instantaneous temperature that evolves in time. FIG. 9 shows voxels of the FEA model assigning reference frame and indexing to each voxel.

For every time step (t), each well must calculate the thermal power going into the voxel and calculate the change in voxel temperature to be applied at the next step. From each neighboring voxel is a conductive or convective heat transfer. Convective heat transfer coefficient (k_{c}) is substituted for conductive heat transfer coefficient (b) when the neighbor has the material properties of air. For the example of a voxel in the 3D mesh of position index (x, y, z), assuming all neighboring voxels are conductively transferring heat, P_{x,y,z}(t) is represented as shown in Equation 35.

$${P}_{x , y , z} ( t ) = {k}_{x , y , z + 1} WL ( {T}_{x , y , z + 1} ( t ) - {T}_{x , y , z} ( t ) ) + {k}_{x , y , z - 1} WL ( {T}_{x , y , z - 1} ( t ) - {T}_{x , y , z} ( t ) ) + {k}_{x , y - 1 , z} WH ( {T}_{x , y - 1 , z} ( t ) - {T}_{x , y , z} ( t ) ) + {k}_{x + 1 , y , z} HL ( {T}_{x + 1 , y , z} ( t ) - {T}_{x , y , z} ( t ) ) + {k}_{x , y + 1 , z} WH ( {T}_{x , y + 1 , z} ( t ) - {T}_{x , y , z} ( t ) ) + {k}_{x - 1 , y ,} HL ( {T}_{x - 1 , y , z} ( t ) - {T}_{x , y , z} ( t ) ) \qquad ( Equation 35 )$$

The temperature of the voxel evolves as a function of the time step, as shown in Equation 36.

$${T}_{x , y , z} ( {t}_{1} ) = {T}_{x , y , z} ( {t}_{0} ) + {\int }_{{t}_{0}}^{{t}_{1}} \frac{{P}_{x , y , z} ( τ )}{{κ}_{x , y , z}} d τ \qquad ( Equation 36 )$$

Beginning with a known or assumed starting condition of temperature for each voxel, and knowing the temperature through time of the environment, we can using this FEA method to estimate the temperature through time of the sample in individual wells. As discussed below in the “Initial Conditions” section, it is not actually required to even know the initial conditions so long as the environmental temperature through time is known for several thermal time constant prior to using the sample temperature estimates.

Estimation from Empirical Measurements

Another way in which the temperature through time of fluid samples in well plates may be estimated is by directly measuring the temperature of samples in wells as the environment temperature is changed as a function of various parameters of interest (e.g. the sample volume and topology of sample locations), and using these measured values to estimate the temperature through time generally for future samples. The temperature through time may be measured using any suitable method. For example, the temperature may be measured with thermometers placed directly in fluid in wells, using blackbody based infrared sensors, using thermal imaging systems that measure temperature based on the spectrum of radiation emitted by the sample, and/or using dynamic light scattering or related technologies that measure the diffusion coefficient of particles of known radius in solution, from which the absolute temperature of the fluid may be calculated.

As an example, a well plate may be prepared with samples having different topologies of sample placement and differing fluid volumes, the well plate may be equilibrated to room temperature, and then the well plate may be placed into a system at a significantly different temperature from room temperature, resulting in a step change in the environmental temperature. The temperature change of each sample may be measured through time, and the functional form and time constant associated with each condition may be directly measured.

FIG. 10 shows an example well plate 1000 having a first portion of the wells 1002 prepared with sample, indicated by dark squares, and a second portion of the wells 1004 left empty (e.g., the wells containing air). The example well plate 1000 includes a variety of topologies of sample placement, such as a singular unconnected sample 1006 and an assortment of topologies of connected regions. These sample arrangements may be used to empirically determine thermal lag between samples and the environment.

Given the response of samples to a step change in temperature, standard convolution algorithms may be used to calculate the impulse response function. Knowing the impulse response function and assuming a linear system, the general response to a changing environmental temperature through time Tₑₙᵥ(t) may be calculated as the convolution of the impulse response function with Tₑₙᵥ(t). The impulse response function may be parameterized (e.g. as an exponential function, or stretched exponential, or double exponential, or similar). The optimal parameters to use for a general sample with any fluid volume, sample placement topology, etc., may, for example, be obtained from interpolation or from extrapolation from a lookup table over the range for which the parameters which were measured. In other examples, the parameters may themselves be parameterized as a function of fluid volume, sample placement topology, etc.

Another way in which empirical data may be used to predict Tₛₐₘₚ(t) from Tₑₙᵥ(t) as a function of the fluid volume, sample placement topology, etc., is for data to be acquired over a broad range of conditions and environmental temperature changes, and to use a machine learning algorithm to correlate Tₑₙᵥ(t) to Tₛₐₘₚ(t) as a function of the fluid volume, sample placement topology, etc. Any other suitable method may be used to employ empirical data to predict Tₛₐₘₚ(t) from Tₑₙᵥ(t) as a function of the fluid volume, sample placement topology, etc.

### Combining Methods

Disclosed above are the three general methods (e.g., calculation based upon a theoretical model, calculation based on a finite element analysis model of the system, and estimation from empirical measurements along with interpolation or extrapolation to specific conditions) for thermal modeling to improve the estimate of the temperature of a fluid sample in a well plate. In addition to using any of these three methods individually, methods disclosed herein may be combined in order to improve the estimate of the temperature of a fluid sample. For example, for the case of the theoretical model, various thermal parameters must be known, such as the thermal conductivity of the materials in a well plate or the efficiency with which air transmits heat energy to the various surfaces of interest. Those parameters may be experimentally determined using the empirical method described above and then those parameters may be used by the theoretical method or the FEA method for calculating sample temperature.

### Initial Conditions

The modeling methods disclosed herein include the initial conditions of sample, environment, and/or sample holder temperature as a part of the model. However, as time progresses, the initial condition has a decreasing amount of impact on the temperature of the sample. After several thermal time constants, the system temperature will be essentially uninfluenced by the initial temperature conditions. It is therefore possible to assume almost any initial sample condition, and so long as the well plate is held at known temperatures for several thermal time constants. Given these conditions, the modeled temperature will be accurate regardless of the initial sample condition assumed.

### Optimal Plate Layout

In certain embodiments, the improved sample temperature estimating approaches described herein may be applied recursively to determine an optimal plate layout that minimizes temperature variation across the wells. In many practical applications, not every well in a plate is filled with a sample. Rather, users often load wells sequentially, concentrate them in localized regions, or organize them based on other characteristics. However, these conventional layouts are typically suboptimal for achieving uniform thermal conditions, as thermal uniformity is enhanced when each sample is surrounded by matching neighbors to the greatest spatial extent possible. By leveraging the examples disclosed herein, optimal sample layouts can be determined for any combination of filled or unfilled wells, as well as for different sample type and volume variations. In certain embodiments, the optimization may additionally include filling “dummy” wells with a suitable solvent to further enhance thermal uniformity across the plate.

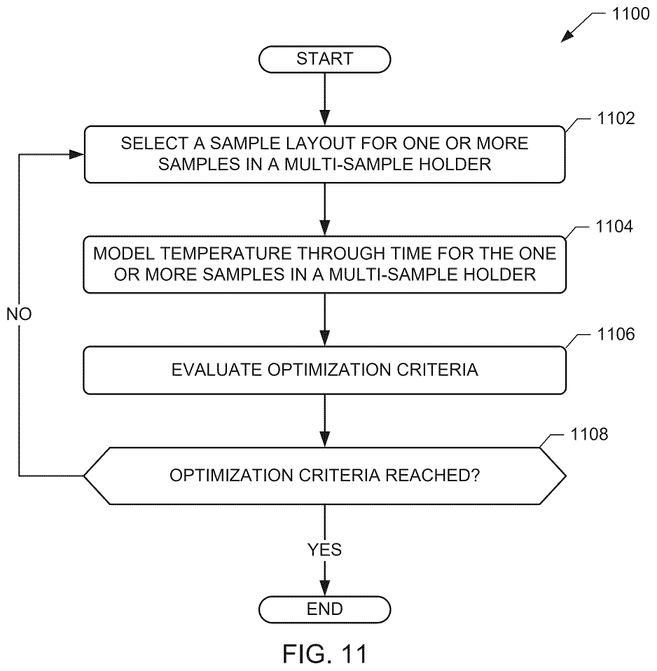

FIG. 11 is a flow diagram illustrating an example procedure 1100 for optimizing sample layouts in a multi-sample holder, according to an example embodiment of the present disclosure. Although the procedure 1100 is described with reference to the flow diagram illustrated in FIG. 11, it should be appreciated that many other methods of performing the functions associated with the procedure 1100 may be used. For example, the order of the blocks may be changed, certain blocks may be combined with other blocks, and many of the blocks described are optional.

The example procedure 1100 begins at block 1102 when a sample layout for one or more samples in a multi-sample holder is selected. For example, for a given multi-sample holder, the position of one or more samples within the multi-sample holder will be selected. The selection may include placement of one or more dummy samples which include only a suitable solvent. The selection may further include selecting a volume of each sample and a sample type. In some examples, the selection of block 1102 may be a manual selection where a user chooses the location of each non-dummy sample and/or dummy sample. In other examples, the selection of block 1102 may be done by a processor of a computer (e.g., a processor of the computer system 306 of FIG. 3). In some examples, the selection of sample locations may be based on prior optimization results.

At block 1104, the processor of the computer models the temperature through time for the one or more samples within the multi-sample holder for the selected layout. For example, one or more of the modeling techniques disclosed herein (e.g., calculation based upon a theoretical model, calculation based on a finite element analysis model of the system, estimation from empirical measurements along with interpolation or extrapolation to specific conditions, or a combination of any of the above) may be used to model the temperature through time for each of the samples in the multi-sample holder for a given air temperature input. The example air temperature input may include a step change of the air temperature, a gradual increase or decrease of the air temperature, or any other suitable air temperature profile over time.

At block 1106, the modeled sample temperatures through time are evaluated against an optimization criteria. For example, the procedure 1100 may be designed to optimize the sample layout by minimizing a temperature lag time between the fluid samples and the environment of the multi-sample holder. Accordingly, in this example, the modeled sample temperatures are evaluated to determine the temperature lag between the modeled sample temperatures and the input air temperature. In another example, the procedure 1100 may be designed to minimize errors in the modeling of the temperature through time of the one or more fluid samples. Accordingly, in this example, the modeled temperatures would be compared to actual temperatures that were measured directly using, for example, one of the approaches described in paragraph 0150. In other examples, optimization criteria may be the uniformity of sample temperature across the multi-sample holder or across a subset of samples (e.g., samples in a connected region, wells having the same sample content, etc.).

At block 1108, it is determined whether or not the selected sample layout achieves an optimization criteria (e.g., target). For example, if optimizing the sample layout for temperature lag, the optimization target may be a maximum or average temperature lag. If the selected sample layout does not achieve (e.g., is at or above the maximum or average temperature lag) the optimization criteria, the procedure 1100 returns to block 1102 to select a new sample layout. If the selected sample layout achieves (e.g., is at or below the maximum or average temperature lag) the optimization criteria, the selected sample layout may be stored as an optimized sample layout and the procedure 1100 of FIG. 11 ends.

Example methods disclosed herein may be improved or refined by considering additional factors such as corner neighbors in addition to heat conduction into a well from the top, bottom, and each of the four nearest adjacent wells. Further enhancements to the methods disclosed herein may include the consideration of the thermal mass of walls and sample layouts having different sample volumes in different wells leading to differing heat conduction areas. Additionally, the thermal modeling disclosed herein may be improved by making the model higher fidelity with regard to specific geometry, including the thermal mass of sidewalls in the modeling, and/or making fewer simplifying assumptions.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112(f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

The invention is claimed as follows:

1. A method for estimating the temperature through time of a specified fluid sample in a multi-sample holder, the method comprising:
modeling the temperature through time of one or more fluid samples in a connected region, the connected region including the specified fluid sample, wherein the modeling is based on properties of the multi-sample holder and properties of the one or more fluid samples.

2. The method of claim 1, wherein the properties of the multi-sample holder include one or more of thermal conductivity of the material of the multi-sample holder, heat capacity of the material, thickness of the material, and shape of individual fluid sample holders.

3. The method of claim 1, wherein the properties of the one or more fluid samples include one or more of fluid sample volume, heat capacity of the fluid sample, sample location in the multi-sample holder, sample location in the connected region, presence of an evaporation barrier, and characteristics of the evaporation barrier.

4. The method of claim 1, wherein the modeling is performed using theoretical models with coupled integral or differential equations, wherein a number of the coupled integral or differential equations is the same as a number of the fluid samples in the connected region.

5. The method of claim 4, wherein the coupled integral or differential equations are solved numerically.

6. The method of claim 1, wherein the modeling is performed using theoretical models with uncoupled integral or differential equations.

7. The method of claim 6, wherein the uncoupled integral or differential equations are solved numerically.

8. The method of claim 1, wherein the modeling is performed using finite element analysis methods.

9. The method of claim 1, wherein the modeling is performed using an empirical method.

10. The method of claim 9, wherein the empirical method includes interpolating the temperature through time of the one or more fluid samples from empirical data.

11. The method of claim 9, wherein the empirical method includes extrapolating the temperature through time of the one or more fluid samples from empirical data.

12. The method of claim 9, wherein the empirical method includes:
fitting measured values to functional forms as a function of multi-sample holder and sample parameters; and
using the functional forms to estimate the temperature through time.

13. The method of claim 1, wherein the modeling is based on a combination of theoretical models with integral or differential equations and empirical results.

14. The method of claim 1, wherein the modeling is based on a combination of finite element analysis models and empirical results.

15. A method of optimizing placement of fluid samples in a multi-sample holder, the method comprising:
modeling the temperature through time of one or more fluid samples in a connected region, wherein the modeling is based on properties of the multi-sample holder and properties of the one or more fluid sample; and
optimizing the placement of samples based on the modeling to minimize temperature lag time between the fluid samples and the environment of the multi-sample holder.

16. The method of claim 15, wherein the modeling is performed using theoretical models with coupled integral or differential equations, wherein a number of the coupled integral or differential equations is the same as a number of the fluid samples in the connected region.

17. The method of claim 15, wherein the modeling is performed using theoretical models with uncoupled integral or differential equations.

18. The method of claim 15, wherein the modeling is performed using finite element analysis methods.

19. The method of claim 15, wherein the modeling is performed using an empirical method.

20. The method of claim 15, wherein the modeling is based on a combination of theoretical models with integral or differential equations and empirical results.

21. The method of claim 15, wherein the modeling is based on a combination of finite element analysis models and empirical results.

22. The method of claim 15, wherein the optimizing includes placement of dummy solvent samples to improve uniformity of the fluid sample temperatures.

23. A method of optimizing placement of fluid samples in a multi-sample holder, the method comprising:
modeling the temperature through time of one or more fluid samples in a connected region, wherein the modeling is based on properties of the multi-sample holder and properties of the one or more fluid sample; and
optimizing the placement of samples based on the modeling to minimize errors in the modeling of the temperature through time of the one or more fluid samples.

24. The method of claim 23, wherein the modeling is performed using a combination of one or more of theoretical models, finite element analysis methods, and empirical models.
